(19) United States
(12) Patent Application Publication
(10) Pub. No.: US 2008/0232265 A1
(43) Pub. Date: Sep. 25, 2008

(54) Communication terminal, data exchange method, and computer product

(75) Inventor: Yoshitake Kakiuchi, Ichikawa (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED

(21) Appl. No.: 11/826,454

(22) Filed: Jul. 16, 2007

Related U.S. Application Data
(63) Continuation of application No. PCT/JP05/00408, filed on Jan. 14, 2005.

(51) Int. Cl. H04L 12/26

(52) U.S. Cl. 370/252

(57) ABSTRACT

When a first communication terminal retrieves data from a second communication terminal, the first communication terminal increases a reliability rank of the second communication terminal if the user of the first communication terminal selects a piece of data retrieved from the second communication terminals. When providing data to the second communication terminal, the first communication terminal controls data to be provided to the second communication terminal based on the reliability rank of the second communication terminal.

### BACKGROUND OF THE INVENTION

1. Field of the Invention

The present invention relates to a technology for searching and transmitting data that corresponds to a received search request, and receiving a search result corresponding to a transmitted search request.

2. Description of the Related Art

In a widely known and commonly used method, terminals such as a mobile phone or a Personal Digital Assistant (PDA) that enable communication with an unspecified number of other terminals are used to form a community as a place of data exchange. In such a community, when a user issues a data provision request by inputting in a terminal a keyword of desired data, a terminal that possess the data returns the data corresponding to the keyword. In this manner, the users in a community can carry out data exchange among themselves.

For example, a computer program which carries out file exchange between Personal Computers (PC) that are connected to Internet is disclosed in Jnutella.org, “Jnutella”, [online], [searched on Dec. 7, 2004], Internet (URL:http://www.jnutella.org/). Furthermore, a community forming system, which is disclosed in Japanese Patent Laid-open Application No. 2002-245212, controls a plurality of communities according to the user's preference on a server that is connected to the Internet, and carries out restructuring of the communities according to an activity level of each community.

Usage of the computer program and the community forming system disclosed in the above mentioned references enables the user to extract desired data from an unspecified number of terminals and also enables to provide the data corresponding to a request from a terminal affiliated to a community.

However, even after using technologies that are disclosed in the above mentioned references, survival and expansion of the community depends on the quality of the users affiliated to the community. In other words, because an amount of used data and an amount of provided data normally varies for each user affiliated to the community, an increase in the number of users who only use data without providing data results in a decline of the community itself.

Including a server that is bound to the terminal of each user and limiting the amount of data usage for the users who contribute a small amount of provided data can overcome the drawback. However, using the server necessitates significant efforts to run the community and the community cannot be expanded flexibly.

### SUMMARY OF THE INVENTION

It is an object of the present invention to at least partially solve the problems in the conventional technology.

According to an aspect of the present invention, a communication terminal that transmits by searching data corresponding to a received search request and receives search results matching with the transmitted search request to carry out a data exchange includes a storage unit that stores therein reliability ranks that indicate a reliability of each communicating partner; an updating unit that updates the reliability ranks that have been stored in the storage unit based on certain conditions; and a determining unit that determines a search range of data to be provided to a communicating partner based on a reliability rank of the communicating partner that has been stored in the storage unit.

According to another aspect of the present invention, a computer-readable recording medium that stores therein a computer program that causes a computer to transmit by searching the data corresponding to the received search request and receive the search results of the transmitted search request to carry out the data exchange causes the computer to execute storing reliability ranks, which indicate a reliability of each communicating partner, in a storage unit; updating the reliability ranks that have been stored in the storage unit based on certain conditions; and determining a search range of data to be provided to a communicating partner based on a reliability rank of the communicating partner that has been stored in the storage unit.

According to still another aspect of the present invention, a method of data exchange including transmitting by searching the data corresponding to the received search request and receiving the search results of the transmitted search request to carry out the data exchange includes storing reliability ranks, which indicate a reliability of each communicating partner, in a storage unit; updating the reliability ranks that have been stored in the storage unit based on certain conditions; and determining a search range of data to be provided to a communicating partner based on a reliability rank of the communicating partner that has been stored in the storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining a data exchanging process according to an embodiment of the present invention;

FIG. 2 is a functional block diagram of a communication terminal shown in FIG. 1;

FIG. 3 is an example of contents of a provided data list shown in FIG. 1;

FIG. 4 is the example of contents of a terminal rank list shown in FIG. 1;

FIG. 5 is the example of contents of a reliability-setting list;

FIG. 6 is the schematic of contents of a data retrieval process shown in FIG. 1;

FIG. 7 is a flowchart of the data retrieval process;

FIG. 8 is the schematic for explaining a data providing process;

FIG. 9 is the flowchart of the data providing process; and

FIG. 10 is a block diagram of a computer that implements the methods, processes, or steps according to the embodiment.

### DETAILED DESCRIPTION OF THE PREFERRED EMBODIMENTS

Exemplary embodiments according to the present invention are explained below with reference to the accompanying drawings. However, the present invention is not limited to the embodiments explained below.

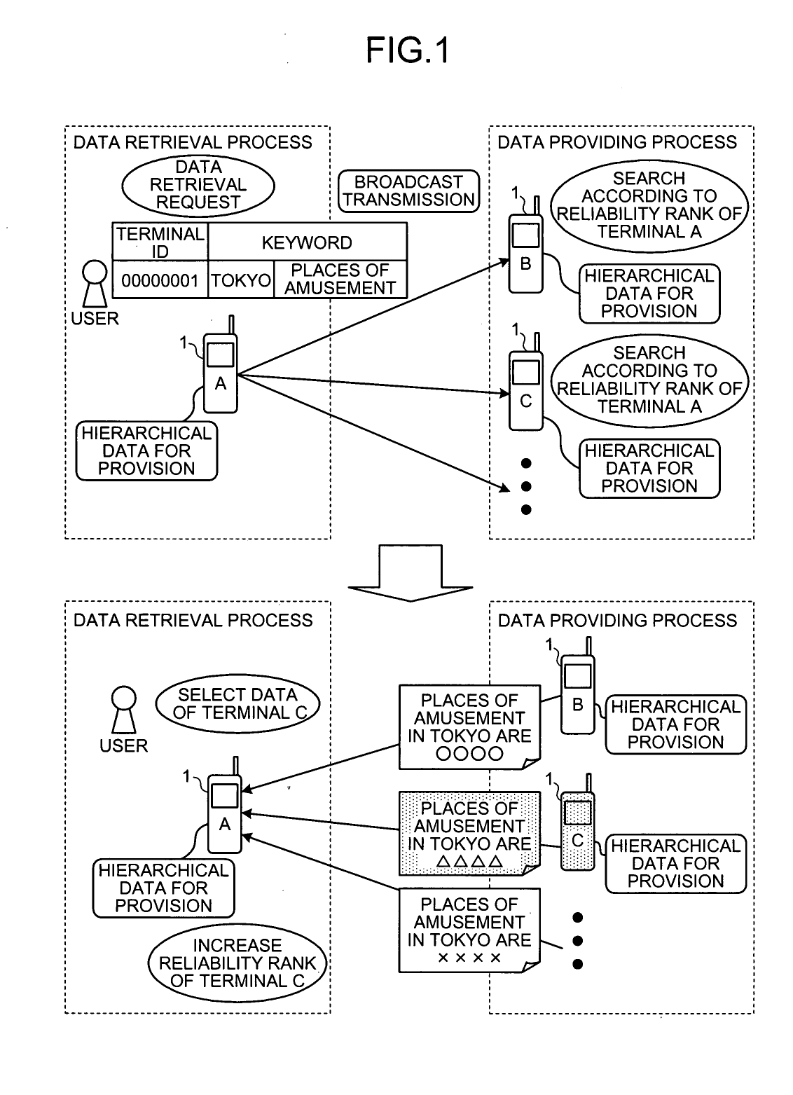

FIG. 1 is a schematic for explaining a data exchanging process according to an embodiment of the present invention. As shown in FIG. 1, a plularity of communication terminals 1, which include a terminal A, a terminal B, and a terminal C, posses hierarchical data for provision, i.e., data that can be sent to other terminals. The communication terminals 1 carry out exchange (transmission and reception) of data among each other using wireless communication etc.

Transmission of a data provision request message by a user of the terminal A is explained first. When the user operates the terminal A and inputs keywords for searching desired data, a data provision request message is generated that includes a terminal identification (ID) (“00000001” in FIG. 1) and search keywords (“Tokyo” and “places of amusement” in FIG. 1). When the user presses a transmit button of the terminal A, the data provision request message is broadcast transmitted to the other terminals.

Upon receiving the data provision request message, the terminal B and the terminal C search the hierarchical data for provision included in the terminal B and the terminal C itself and return search results to the terminal A. When searching the data for provision, the terminal B and the terminal C determine a search range of the data for provision according to a reliability rank, of the terminal A, included in the terminal B and the terminal C itself, and search the data for provision according to the determined search range. The search results of each terminal are transmitted to the terminal A.

Reception of the search results by the terminal A is explained next. Upon receiving the search results, the terminal A displays a list of each search result and promotes a selection by the user. If the user determines that the data received from the terminal C is effective and selects the data from the list, the terminal A increases the reliability rank of the terminal C. In the present embodiment, every time a receiving terminal saves therein data received from a source terminal, the receiving terminal increments the current credit points of the source terminal. As a result, a terminal can determine the reliability rank of any other terminal from the credit points of the other terminal.

Thus, each of the communication terminals 1 includes the hierarchical data for provision and the reliability ranks that indicate reliability of the other terminals. Upon receiving a data provision request from a terminal of higher reliability rank, the communication terminals 1 search the data for provision in a wide range according to the reliability rank. Furthermore, when retrieving the data, the communication terminals 1 increase the reliability rank of the terminal to which the user has transmitted the selected data.

In a commonly used data exchanging process, because the data for provision is searched in a uniform range without considering the reliability ranks, imbalance occurs between an amount of used data and an amount of provided data by each user who is affiliated to the community, thus hampering a healthy expansion of the community. Further, when data is to be provided only to specific partners such as data providing partners without disclosing the data to unspecified partners, the user needs to constantly monitor a status of the communication program and change the search range of the data for provision each time. Thus, there is a large workload on the user.

In a data exchanging process according to the embodiment, a concept of the reliability rank of each terminal is introduced and the reliability rank of the terminal that provides effective data is increased. Thus, upon increasing the reliability rank, more data can be retrieved. A balance can be maintained between the amount of used data and the amount of provided data by each user affiliated to the community, thereby enabling to contribute towards expansion of the community. A computer program loaded on the communication terminals 1 executes a process to modify the reliability ranks and a process to search the data for provision according to the reliability ranks, thereby enabling to reduce the workload of the user.

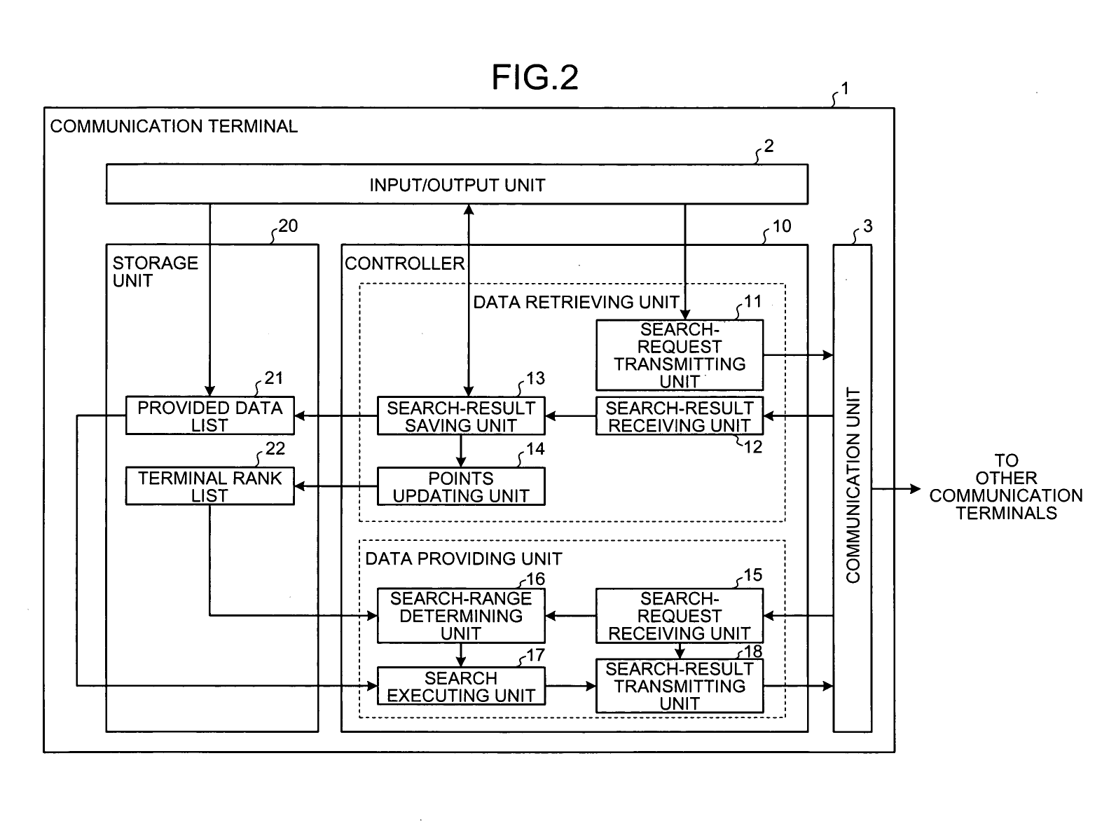

Next, a structure of the communication terminals 1 is explained with reference to FIG. 2. FIG. 2 is a functional block diagram of any one of the communication terminals 1. The communication terminal 1 includes an input/output unit 2, a communication unit 3, a controller 10, and a storage unit 20.

The controller 10 includes a data retrieving unit and a data providing unit. The data retrieving unit includes a search-request transmitting unit 11, a search-result receiving unit 12, a search-result saving unit 13, and a points updating unit 14. The data providing unit includes a search-request receiving unit 15, a search-range determining unit 16, a search executing unit 17, and a search-result transmitting unit 18. The storage unit 20 includes a provided data list 21 and a terminal rank list 22.

The input/output unit 2 includes input devices such as input buttons, a keyboard, and a card reader and an output device such as a Liquid Crystal Display (LCD). The input/output unit 2 is a processor that receives input operations of the user and also displays the data with respect to the user. The communication unit 3 includes communication devices such as a wireless communication device and a wired communication device. The communication unit 3 is the processor that receives data from and transmits data to unspecified number of other communication terminals 1.

The controller 10 is the processor that, based on the operations of the user, transmits a search request to the other communication terminals 1 when the user retrieves data and submits the received search results to the user via the input/output unit 2. The controller 10 stores into the storage unit 20, the search results selected by the user and also updates reliability points of the communication terminals 1 that provide the search results. Furthermore, when the search request is received from the other communication terminals 1, the controller 10 also searches the provided data list 21 in a range corresponding to ranks of the reliability points and transmits the search results.

The search-request transmitting unit 11 is the processor that generates a search request message that includes the search keywords that are input by the user via the input/output unit 2 and the terminal ID of the terminal itself and transmits the search request message to the other communication terminals 1 via the communication unit 3. Furthermore, the broadcast transmission of the search request message in a predetermined range is explained in the present embodiment; however, the search request message can also be transmitted to the communication terminals 1 that are included in the terminal rank list 22 that is stored in the storage unit 20. Alternatively, by storing a terminal list beforehand in the storage unit 20 via the input/output unit 2, the search request message can also be transmitted to the communication terminals 1 included in the stored terminal list.

The search-result receiving unit 12 is the processor that receives via the communication unit 3, the search results that are transmitted by the other communication terminals 1 and transfers to the search-result saving unit 13. When the search-request transmitting unit 11 broadcast transmits the search request message, the search results are transmitted from a plurality of communication terminals 1. Thus, the search-result receiving unit 12 transfers the search results to the search-result saving unit 13 in a sequence the search results are received.

The search-result saving unit 13 is the processor that submits to the user via the input/output unit 2, the list of the search results that are transferred from the search-result receiving unit 12 and that also transfers to the points updating unit 14 and the provided data list 21, the search results selected upon receiving selection instructions by the user.

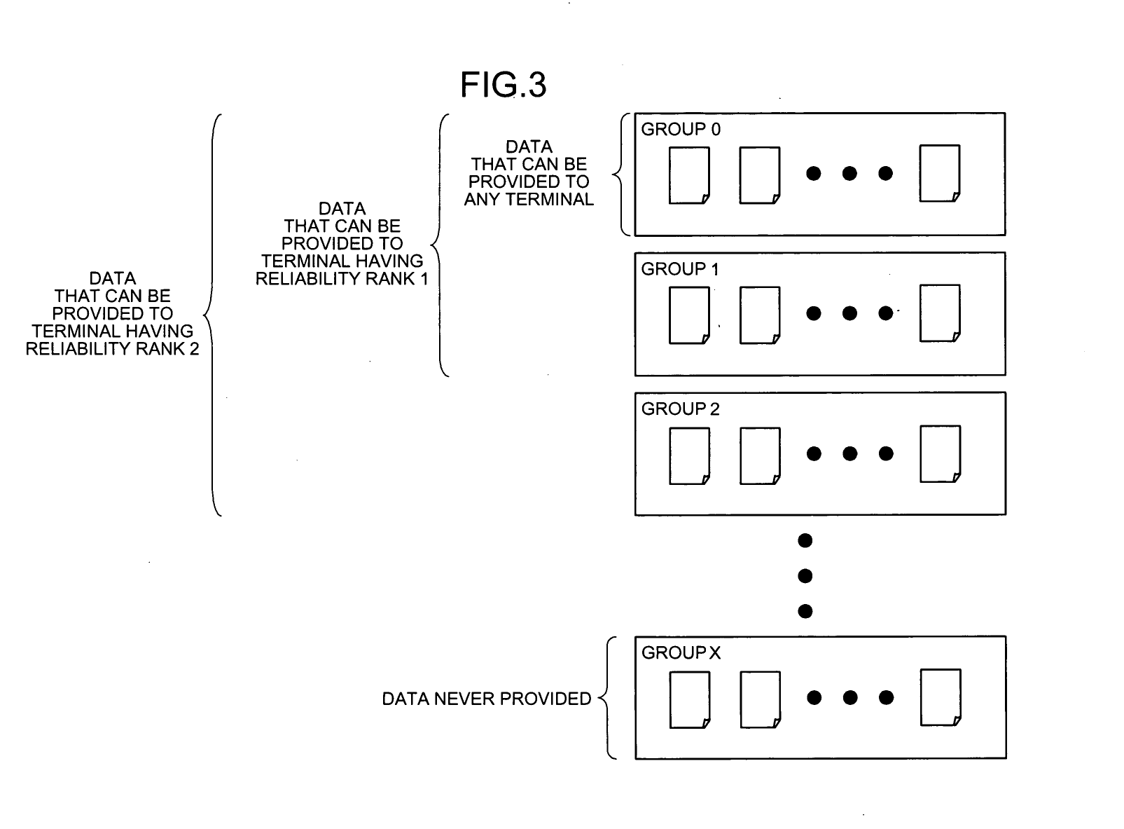

FIG. 3 is the example of contents of the provided data list 21. As shown in FIG. 3, each provided data is divided into a plurality of groups and saved. Each group corresponds to a level of importance of the provided data. For example, the provided data of a group 0 can be provided to any communication terminal 1 and the provided data of a group X is never provided to any communication terminals 1. When the search request is received from the communication terminals 1 of a reliability rank 1, the groups 0 and 1 are targets for searching and when the search request is received from the communication terminals 1 of a reliability rank 2, the groups 0 to 2 are the targets for searching.

The provided data list 21 divides the groups according to the level of importance of the provided data. By increasing the reliability ranks of the communication terminals 1 that issue the search request, a wider range of the provided data can be searched. Furthermore, when the provided data stored in the provided data list 21 is input via the input/output unit 2 and the search results that are received from the other communication terminals 1 are selected by the user, the search-result saving unit 13 adds the selected search results to the provided data list 21. Even if the user has to determine the group to which the data to be added affiliates, hierarchy of a save destination folder is displayed in the input/output unit 2 and a selection screen of the level of importance of data is displayed, thereby reducing the workload of the user.

Returning to FIG. 2, functions of the points updating unit 14 is explained. The points updating unit 14 is the processor that receives the search results that are selected by the user from the search-result saving unit 13, and updates the reliability points of the communication terminals 1 that transmit the search results. To be specific, the points updating unit 14 determines whether the terminal ID of a transmission source that is included in the search results exists in the terminal rank list 22. Upon determining that the terminal ID exists in the terminal rank list 22, the points updating unit 14 adds the points of the corresponding terminal ID and upon determining that the terminal ID does not exist in the terminal rank list 22, adds a new terminal ID of the transmission source.

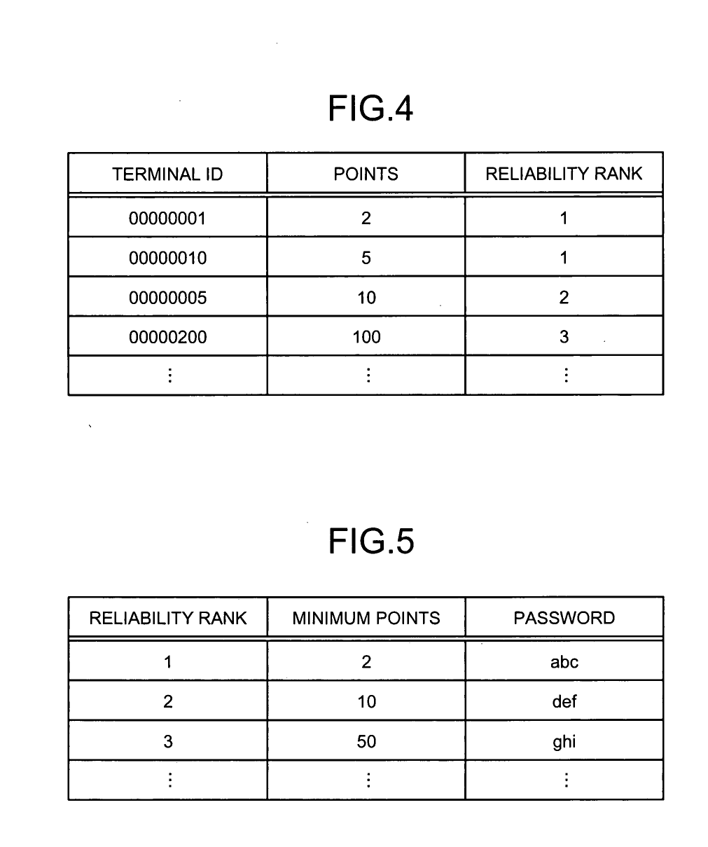

The example of the terminal rank list 22 is explained with reference to FIGS. 4 and 5. FIG. 4 is the example of contents of the terminal rank list 22, and FIG. 5 is the example of contents of a reliability-setting list that is a static list. A control of a dynamically updated list (list shown in FIG. 4) and the static list (list shown in FIG. 5) as separate lists is explained in the present embodiment. Furthermore, a consolidated list of the dynamic list and the static list can also be controlled.

As shown in FIG. 4, the terminal rank list 22 includes items such as “Terminal ID”, “Points”, and “Reliability rank”. In the example shown in FIG. 4, the communication terminal 1 having a terminal ID 00000001 has acquired 2 points and its reliability rank is 1, the communication terminal 1 having a terminal ID 00000200 has acquired 100 points and its reliability rank is 3, The terminal rank list 22 that includes “Reliability rank” is explained in the present embodiment. However, the terminal rank list 22 does not necessarily have to include “Reliability rank”. Assuming “Points” as a key, “Reliability rank” of the reliability-setting list that is shown in FIG. 5 can be retrieved.

As shown in FIG. 5, the reliability-setting list includes items such as “Reliability rank”, “Minimum points”, and “Password”. When determining the “Reliability rank” shown in FIG. 4, the “Points” shown in FIG. 4 and the “Minimum points” shown in FIG. 5 are compared and the corresponding reliability ranks are searched. When the reliability rank is increased, the password that is notified to the selected communication terminals 1 is stored in “Password”. Due to this, the password corresponding to the reliability rank is issued and upon receiving the search request, submission of the password is requested, thereby enabling to prevent fraudulent act due to “Impersonation”.

As shown in FIG. 5, the communication terminal 1 having 1 point has a reliability rank 1, and the communication terminal 1 having 10 points has a reliability rank 2. When points of the communication terminal 1 having 9 points increase to 10 points because of addition of points, a password def is issued to that communication terminal 1.

Returning to FIG. 2, functions of each processor of the data providing unit is explained. The search-request receiving unit 15 is the processor that receives the search request from the other communication terminals 1 via the communication unit 3, and transfers the received search request to the search-range determining unit 16.

The search-range determining unit 16 is the processor that receives the search request from the search-request receiving unit 15 and by treating the terminal ID of a request source that is included in the received search request as the key, searches the terminal rank list 22 and by retrieving terminal ranks, and determines the search range of the provided data list 21. For example, as shown in FIG. 4, when the search request is received from the communication terminal 1 having the terminal ID 00000005, because the reliability rank of the terminal is 2, the search-range determining unit 16 determines to search the provided data list 21 in the range of the groups 0 to 2 and transfers determined contents to the search executing unit 17.

The search executing unit 17 is the processor that searches the provided data list 21 according to the search range that is determined by the search-range determining unit 16 and transfers to the search-result transmitting unit 18, the search results corresponding to the search request. The search-result transmitting unit 18 is the processor that transmits to the communication terminals 1 of the request source via a communication unit 3, the search results that are received from the search executing unit 17.

The storage unit. 20 includes a nonvolatile memory such as a flash memory. The storage unit 20 stores the provided data list 21 and the terminal rank list 22. As shown in FIG. 3, the provided data list 21 is a list of data that is divided for each group according to the level of importance of data. As shown in FIGS. 4 and 5, the terminal rank list 22 controls the reliability rank of each of the communication terminals 1.

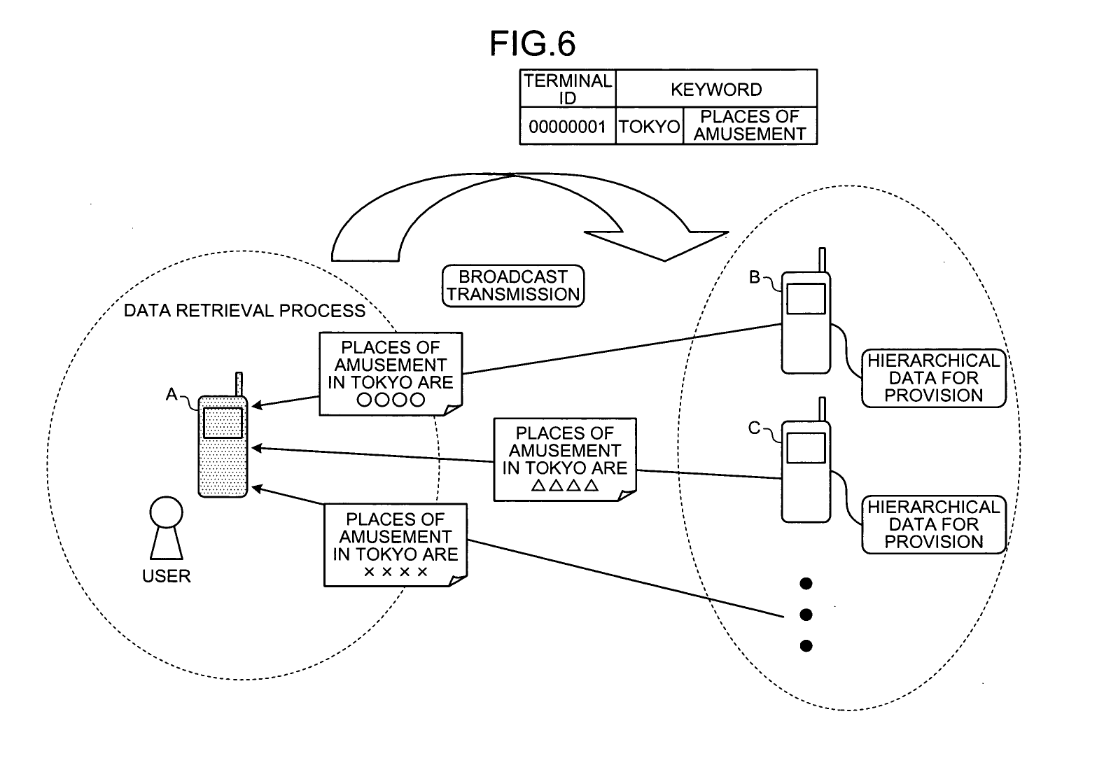

Next, the data exchanging process according to the present embodiment is explained by dividing into a data retrieval process and a data providing process. The data retrieval process according to the present embodiment is explained with reference to FIG. 6 first. FIG. 6 is the schematic for explaining the data retrieval process. As shown in FIG. 6, the user of a communication terminal A issues the search request and receives the search results from the other communication terminals (B and C).

To be specific, upon receiving the broadcast transmitted search request, each of the other communication terminals (B and C) refers to the reliability rank of the communication terminal A using the terminal rank list 22 that is stored in the terminal itself and by searching the provided data list 21 that is stored in the terminal itself in a range according to the reliability ranks, transmits the search results to the communication terminal A. Upon receiving the search results, the communication terminal A displays the list of the search results and saves the search results selected by the user in the terminal itself and also updates the reliability rank of the terminal that transmits the selected search results.

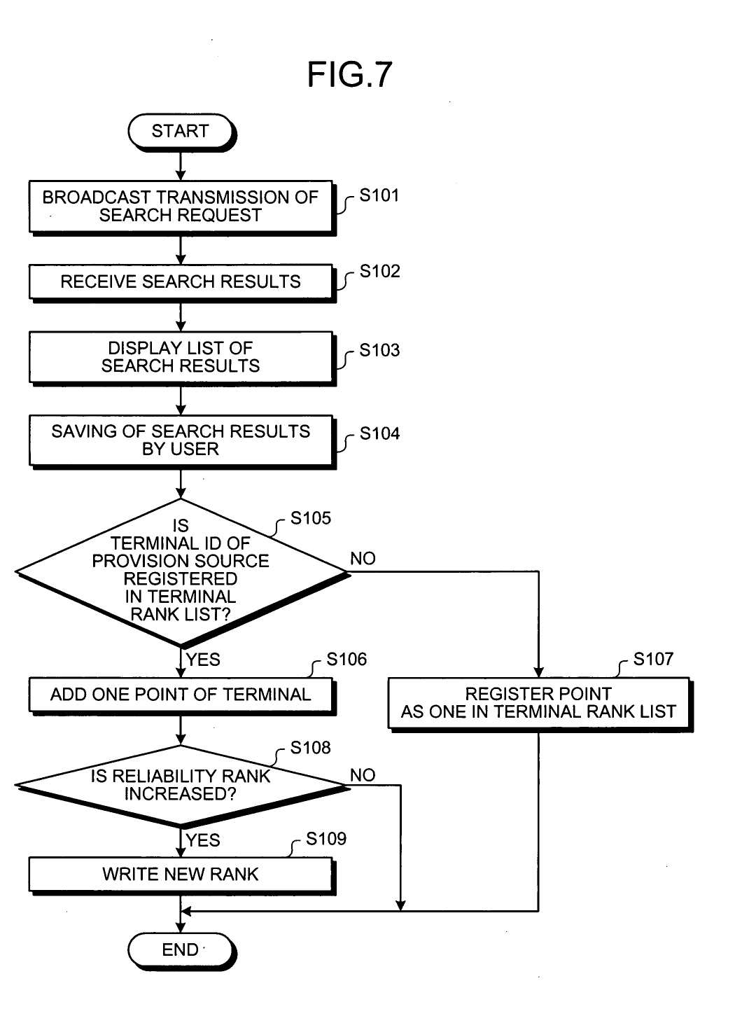

Next, the sequence of the data retrieval process that is shown in FIG. 6 is explained with reference to FIG. 7. FIG. 7 is a flowchart of the data retrieval process. As shown in FIG. 7, when the user inputs the search keyword via the input/output unit 2, the search-request transmitting unit 11 broadcast transmits via the communication unit 3, the search request message that includes the input search keyword and the terminal ID of the terminal itself (step S101). Upon receiving the search results from the other communication terminals 1 via the communication unit 3 (step S102), the search-result receiving unit 12 transfers the received search results to the search-result saving unit 13 and the search-result saving unit 13 displays the list of the search results via the input/output unit 2 (step S103).

Next, upon referring to the displayed list of the search results, if the user saves the search results that are determined as effective, the search-result saving unit 13 adds the selected search results to the provided data list 21 (step S104) and also notifies to the points updating unit 14. The points updating unit 14 that receives notification determines whether the terminal ID of the communication terminals 1 that provide the search results is registered in the terminal rank list 22 (step S105).

When the terminal ID is registered in the terminal rank list 22 (Yes at step S105), one reliability point corresponding to the terminal ID is added (step S106). If the terminal ID is not registered in the terminal rank list 22 (No at step S105), after treating the reliability point corresponding to the terminal ID as one, a new reliability point is registered in the terminal rank list 22 (step S107) and the data retrieval process ends.

In the present embodiment, even if the point is added one by one, the point that reflects the level of importance, which is determined by the user, can also be added. For example, the user sets the point for each group of the provided data list 21 in which the search results are saved. When the search results are saved in the group having a higher importance level, greater points can be assigned to the group having a higher importance level than the group having a low importance level.

Next, upon adding the points, the points updating unit 14 determines whether the reliability rank of the terminal ID is to be increased (step S108). If the reliability rank is to be increased (Yes at step S108), the points updating unit 14 writes a new reliability rank in the terminal rank list 22 (step S109) and ends the data retrieval process. On the other hand, if the reliability rank is not to be increased (No at step S108), the data retrieval process ends without modifying the reliability rank.

Because the reliability ranks of the transmission source (communication terminals 1) of the search results selected by the user are updated upon submitting the list of the received search results, the reliability rank can be enhanced by providing more and more effective data and more effective data can be retrieved by widening the search range of the provided data list 21.

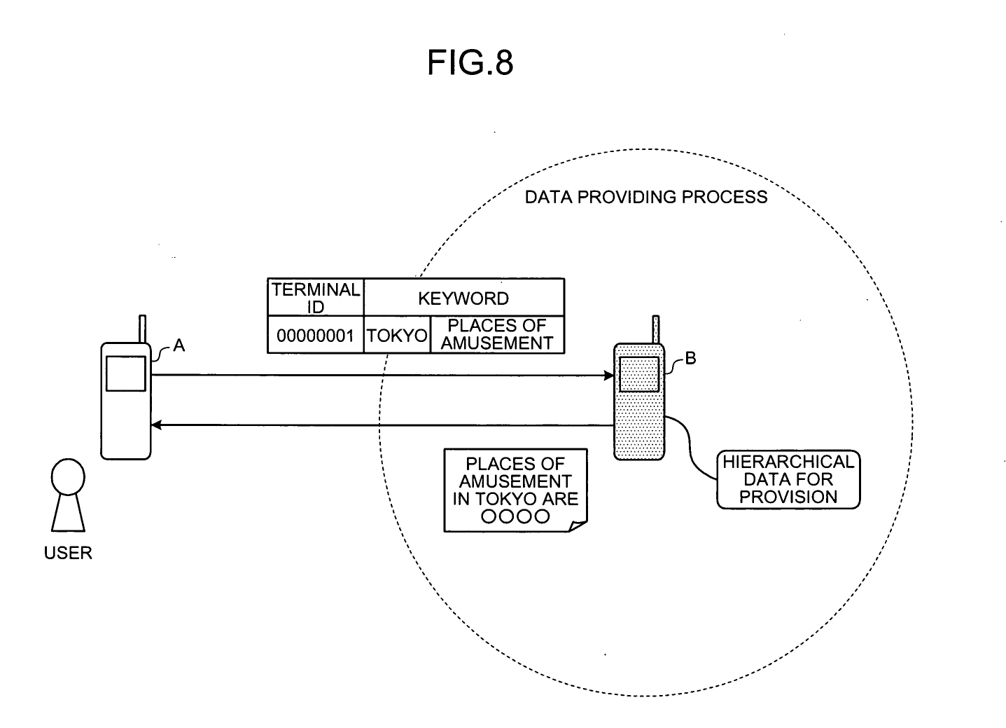

FIG. 8 is the schematic for explaining the data providing process. As shown in FIG. 8, the user of the communication terminal A issues the search request. Upon receiving the search request, the communication terminal B searches the data for provision that is stored in the terminal itself and returns the search results. To be specific, the communication terminal B that receives the broadcast transmitted search request refers to the reliability ranks of the communication terminal A using the terminal rank list 22 that is stored in the terminal itself and by searching in the range according to the reliability ranks, the provided data list 21 that is stored in the terminal itself, transmits the search results to the communication terminal A.

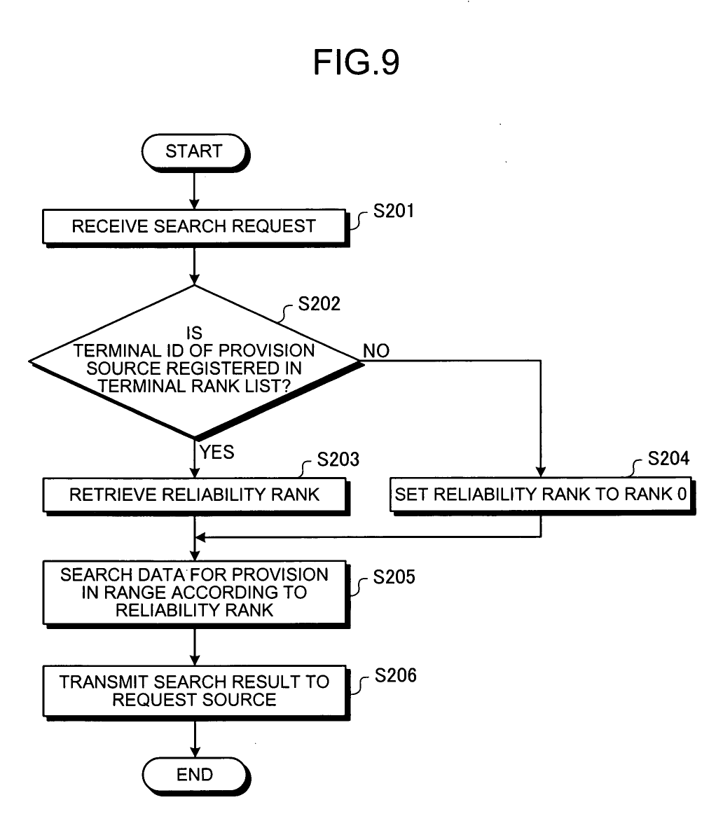

Next, the sequence of the data providing process shown in FIG. 8 is explained with reference to FIG. 9. FIG. 9 is the flowchart of the data providing process. As shown in FIG. 9, when the search-request receiving unit 15 receives the search request via the communication unit 3 (step S201), the search-range determining unit 16 determines whether the terminal ID of the communication terminals 1 that transmit the search request is registered in the terminal rank list 22 (step S202).

If the terminal ID is registered in the terminal rank list 22 (Yes at step S202), the search-range determining unit 16 retrieves the reliability rank corresponding to the terminal ID (step S203). However, if the terminal ID is not registered in the terminal rank list 22 (No at step S202), the search-range determining unit 16 sets zero (0) to the reliability rank corresponding to the terminal ID (step S204).

Next, the search executing unit 17 searches the provided data list 21 in the search range according to the reliability ranks (step S205) and transfers the search results to the search-result transmitting unit 18. The search-result transmitting unit 18 that receives the search results transmits the search results to the communication terminals 1 of the request source via the communication unit 3 (step S206) and ends the data providing process.

Because the search range of the provided data can be modified according to the reliability ranks of the communication terminals 1 that transmit the search request, the communication terminals 1 that provide the effective data can retrieve more data and because the communication terminals 1 that do not provide the effective data can retrieve the limited data, the balance can be maintained between the amount of used data and the amount of provided data by each user who is affiliated to the community.

In the present embodiment as mentioned above, while retrieving the data, if the search-result transmitting unit transmits the search request to the other communication terminals and the search-result receiving unit receives the search results from the other communication terminals, the search-result saving unit instructs to display the list of the search results and adds the selected search results to the provided data list of the storage unit and also updates the reliability ranks of the communication terminals that transmit the selected search results. Furthermore, while providing the data, when the search-request receiving unit receives the search request from the other communication terminals, by referring to the terminal rank list of the storage unit, the search-range determining unit retrieves the reliability ranks of the terminal and determines the search range of the provided data list. The search executing unit searches the provided data based on the search range and the search-result transmitting unit transmits the search results to the communication terminals of the request source. Consequently, by increasing the reliability ranks of the communication terminals that provide the effective data, the communication terminals having a higher reliability rank can retrieve the wider range of the search results. As a result, the balance can be maintained between the amount of used data and the amount of provided data by each user who is affiliated to the community, thereby enabling to contribute towards expansion of the community.

In the present embodiment, an application of the present invention to the communication terminals such as a mobile phone or a PDA is explained. However, without limiting to the communication terminals, the present invention, for example, can also be applied to carry out data exchange using a Personal Computer (PC) connected to Internet.

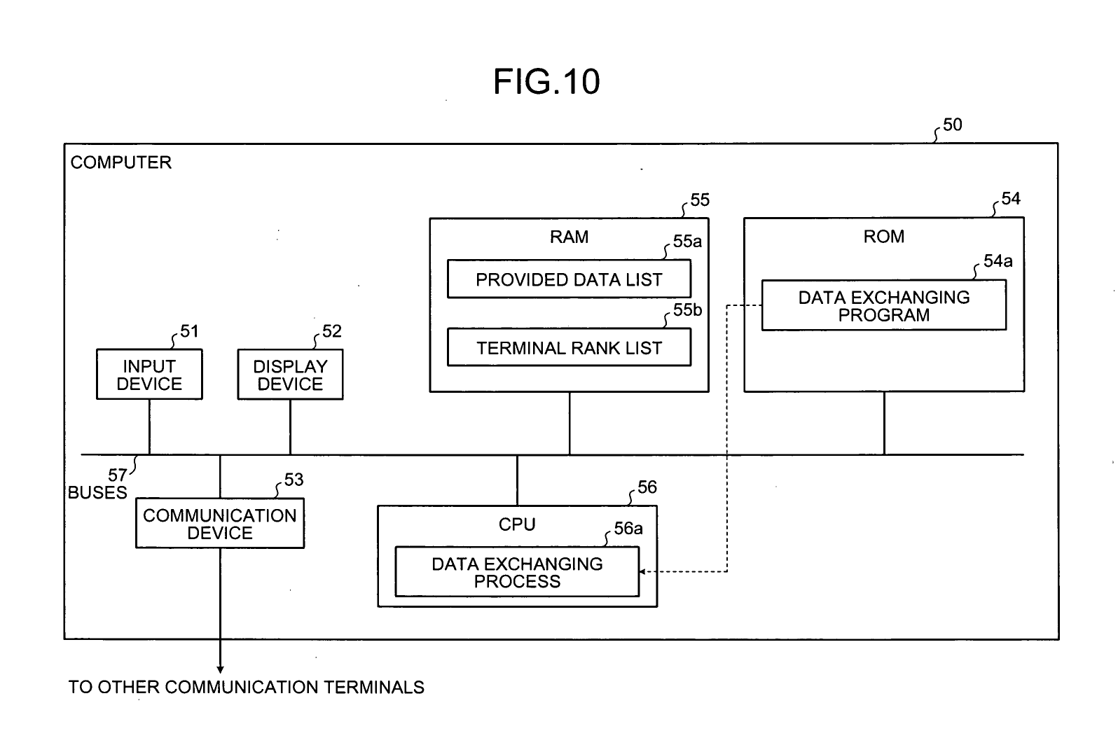

Various processes explained in the present embodiment can be realized by executing prior formulated computer programs on a computer. FIG. 10 is a block diagram of the computer that executes data exchanging programs (communication programs) that include functions similar to the functions explained in the present embodiment.

As shown in FIG. 10, a computer 50 that is the communication terminal includes an input device 51, a display device 52, a communication device 53, a Read Only Memory (ROM) 54, a Random Access Memory (RAM) 55, a Central Processing Unit (CPU) 56 that are connected by buses 57. The input device 51 and the display device 52 correspond to the input/output unit 2 that is shown in FIG. 2 and the communication device 53 corresponds to the communication unit 3. The nonvolatile memory RAM such as the flash memory is used as the RAM 55.

A data exchanging program 54a is stored beforehand in the ROM 54. Furthermore, a provided data list 55a that is stored in the RAM 55 corresponds to the provided data list 21 that is shown in FIG. 2 and a terminal rank list 55b corresponds to the terminal rank list 22. The CPU 56 reads and executes the data exchanging program 54a of the ROM 54 and as shown in FIG. 10, the data exchanging program 54a functions as a data exchanging process 56a.

According to an embodiment of the present invention, it is possible to increase the amount of data that can be retrieved upon enhancing the reliability rank by providing effective data. Further, a balance can be maintained between an amount of used data and an amount of provided data by each user who is affiliated to a community, thereby enabling to contribute towards expansion of the community.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication terminal that transmits by searching data corresponding to a received search request and receives search results matching with the transmitted search request to carry out a data exchange, the communication terminal comprising:
a storage unit that stores therein reliability ranks that indicate a reliability of each communicating partner;
an updating unit that updates the reliability ranks that have been stored in the storage unit based on certain conditions; and
a determining unit that determines a search range of data to be provided to a communicating partner based on a reliability rank of the communicating partner that has been stored in the storage unit.

2. The communication terminal according to claim 1, wherein the updating unit increases, upon selection of the received search results, a reliability rank of a communicating partner that transmitted the search results.

3. The communication terminal according to claim 2, wherein the updating unit increases, based on credit points added upon selection of the received search results, the reliability rank.

4. The communication terminal according to claim 1, wherein the updating unit, upon increase of a reliability rank of a communicating partner above a threshold, issues a password corresponding to the increased reliability rank to the communicating partner.

5. The communication terminal according to claim 1, wherein
the determining unit searches the data to be provided that is divided according to standards of an amount of the data to be provided, and
the updating unit, upon selection of received search results, adds the search results to the data to be provided for each level of importance.

6. A computer-readable recording medium that stores therein a computer program that causes a computer to transmit by searching the data corresponding to the received search request and receive the search results of the transmitted search request to carry out the data exchange, the computer program causing the computer to execute:
storing reliability ranks, which indicate a reliability of each communicating partner, in a storage unit;
updating the reliability ranks that have been stored in the storage unit based on certain conditions; and
determining a search range of data to be provided to a communicating partner based on a reliability rank of the communicating partner that has been stored in the storage unit.

7. The computer-readable recording medium according to claim 6, wherein upon selection of the received search results, the updating includes increasing a reliability rank of a communicating partner that transmitted the search results.

8. The computer-readable recording medium according to claim 7, wherein based on credit points added upon selecting the received search results, the updating includes increasing the reliability rank.

9. The computer-readable recording medium according to claim 6, wherein upon increase of a reliability rank of a communicating partner above a threshold, the updating includes issuing a password corresponding to the increased reliability rank to the communicating partner.

10. The computer-readable recording medium according to claim 6, wherein
the determining includes searching the data to be provided that is divided according to the standards of the amount of the data to be provided, and
upon selection of received search results, the updating includes adding the search results to the data to be provided for each level of importance.

11. A method of data exchange including transmitting by searching the data corresponding to the received search request and receiving the search results of the transmitted search request to carry out the data exchange, the method comprising:
storing reliability ranks, which indicate a reliability of each communicating partner, in a storage unit;
updating the reliability ranks that have been stored in the storage unit based on certain conditions; and
determining a search range of data to be provided to a communicating partner based on a reliability rank of the communicating partner that has been stored in the storage unit.

12. The method according to claim 11, wherein upon selection of the received search results, the updating includes increasing a reliability rank of a communicating partner that transmitted the search results.

13. The method according to claim 12, wherein based on credit points added upon selecting the received search results, the updating includes increasing the reliability rank.

14. The method according to claim 11, wherein upon increase of a reliability rank of a communicating partner above a threshold, the updating includes issuing a password corresponding to the increased reliability rank to the communicating partner.

15. The method according to claim 11, wherein
the determining includes searching the data to be provided that is divided according to the standards of the amount of the data to be provided, and
upon selection of received search results, the updating includes adding the search results to the data to be provided for each level of importance.
